(19) United States
(12) Patent Application Publication
(10) Pub. No.: US 2018/0372031 A1
(43) Pub. Date: Dec. 27, 2018

(54) HEAT EXCHANGER

(71) Applicant: Mahle International GmbH, Stuttgart (DE)

(72) Inventors: Karsten Emrich, Stuttgart (DE); Vahid Havaldar, Stuttgart (DE); Bernd Kraemer, Schwieberdingen (DE); Gaelle Schmidgall, Stuttgart (DE)

(21) Appl. No.: 16/013,915

(22) Filed: Jun. 20, 2018

(30) Foreign Application Priority Data
Jun. 21, 2017 (DE) 102017210400.7

(51) Int. Cl. F02M 26/25; F02M 26/31; F28F 27/02; F28F 21/06

(52) U.S. Cl. CPC F02M 26/25; F02M 26/31; F28F 2255/143; F28F 21/067; F28F 2275/143; F28F 27/02

(57) ABSTRACT

A heat exchanger may include a heat exchanger block and a diffusor connected thereto. At least one connecting pin may be integrally molded to a surface of the heat exchanger block. At least one passage opening, through which the at least one connecting pin may engage when the heat exchanger is mounted, may be arranged on the diffusor. The at least one connecting pin may have a widened head via which the diffusor may be secured to the heat exchanger block.

### CROSS-REFERENCE TO RELATED APPLICATIONS

This application claims priority to German Patent Application No. DE 10 2017 210 400.7, filed on Jun. 21, 2017, the contents of which are incorporated herein by reference in their entirety.

### TECHNICAL FIELD

The present invention relates to a heat exchanger, in particular for an intercooler or an exhaust gas cooler, as well as to a method for the production thereof.

### BACKGROUND

In combustion engines, in particular of motor vehicles, an exhaust gas recirculation is increasingly used for the reduction of the emission of pollutants, whereby the recirculated exhaust gas, which is also understood to be an exhaust gas-air mixture in terms of the invention, must be cooled. On principle, heat exchangers, in particular exhaust gas coolers, make high demands on the temperature stability of the used materials. In addition to a heat exchanger block, such exhaust gas coolers generally have outlet and/or inlet diffusors and, if applicable, other elements, which are fastened to the heat exchanger block, in particular by means of welding, screwing or welded clips.

An exhaust gas cooler comprising a housing and exchanger tubes introduced therein is disclosed from WO 2008/003486 A1. In addition, the exhaust gas cooler has an outlet diffusor, which, prior to an installation, is welded with a first and second floor piece to form a unit, which is then introduced into the housing. After the introduction of the outlet diffusor unit into the housing, an inlet diffusor is fastened to the housing. For this purpose, the inlet diffusor as well as the housing in each case have a projection comprising through holes, by means of which a screw/nut connection or a rivet connection is made.

The execution of the connections known to date of diffusors and also of other parts on the heat exchanger blocks, however, is extensive and the production is thus on principle time and cost-intensive. It is thereby desirable on principle to construct such heat exchanger blocks in a cost-efficient and simple manner.

According to the invention, this problem is solved by means of the subject matters of the independent claims. Advantageous embodiments are the subject matter of the dependent claims.

### SUMMARY

The present invention is based on the general idea of embodying a heat exchanger block in such a way that at least one or optionally several or a plurality of connecting bolts are integrally molded thereon. In this case, the term “integrally molded” means in particular that the connecting bolts are not attached subsequently in response to the fastening or securing of further elements, such as diffusors, to the heat exchanger block, e.g. by means of welding, but that they are produced simultaneously or together with the heat exchanger block. For example, the connecting pin can be arranged on a surface of a housing, in which further elements or parts of the heat exchanger, e.g. heat exchanger tubes, are then introduced. In other words, a heat exchanger block according to the invention has at least one or a plurality of connecting pins or connecting elements, which stick out, on its surface. At least one through hole, through which the connecting pin engages when the heat exchanger is mounted, is arranged on the diffusor. To secure the diffusor to the heat exchanger block, a free end of the connecting pin is widened, in particular in the manner of a rivet head. Further elements, such as an input diffusor and/or an output diffusor, can subsequently be fastened, secured or mounted to the heat exchanger block in a simple manner by means of these connecting pins, which are integrally molded, or which are integral. The connecting pin or the connecting pins can in particular also serve as positioning aid in response to a subsequent fastening or securing of further elements, such as diffusors, for example, and can already secure them against for example lateral shifting, even without final fastening. By providing connecting pins, it can also be possible to save operating steps, such as the subsequent use of rivets or screws or specific tools, such as screw drivers, for establishing a connection with such elements. It can in particular also be possible to reduce cycle times in response to the production of a heat exchanger. The integrally molded connecting pin can also make it possible that the connections, which are embodied by means of the connecting pin, can be embodied to be more permanent than for example by means of a screw/nut connection, which might loosen after a certain period of time. It is particularly advantageous that the diversity of parts and thus the storage and logistics costs can also be reduced by means of the connecting pin, which is arranged integrally on the heat exchanger block.

The surface of the heat exchanger body and of the at least one connecting pin can in particular be embodied of one material or of the same material. On the other hand, the two can also be made of different materials, so that limitations, as they are at hand for example in response to the welding, in the case of which only certain materials can be combined with one another, can be avoided or reduced.

A plurality of connecting pins can further be integrally molded to the surface. The connecting pins can in particular be integrally molded on different sides of the heat exchanger block. It can be made possible through this that a plurality of further elements is subsequently fastened or secured to the heat exchanger block.

In an advantageous further development of the solution according to the invention, the heat exchanger block is cast together with the at least one connecting pin. For example, at least one housing can be cast or formed in one casting. It can be made possible through this that additional parts, such as extra screws, extra rivets or clips, are required in response to the fastening of additional elements. The connecting pin can in particular simply also be embodied in the (casting) mold. The same material can thus be used for the heat exchanger block and for the connecting pins. As a whole, a uniform material can be used for an element of the heat exchanger block in all production processes of the heat exchanger block.

In an advantageous further development of the solution according to the invention, the at least one connecting pin is embodied to be hollow at least on its free end and can thus be deformed. The term “free” or “distal” end is to in particular be understood as the end of the connecting pin, which is not integrally molded to the surface of the heat exchanger block. “Deformable” is to in particular be understood such that the connecting pin is weakened in the sense that a deformation, which is made easier as compared to the massive and/or unweakened connecting pin, is possible. The free end can for example be embodied to be hollow or can be bored from the free end and or a (predetermined) bending point can be integrally molded on the connecting pin. It can thus be made possible in a simple way that a rivet-like connection can be embodied by means of a simple deformation of the connecting pin. Such a “rivet connection” can also provide for a more stable or stronger connection as compared to a screw/nut connection.

The present invention is further based on the general idea of specifying a method for producing a heat exchanger, in which a heat exchanger block is initially produced together with at least one connecting pin, which sticks out from the surface thereof. A diffuser, which is attached to the heat exchanger block in such a way that the at least one connecting pin engages through a corresponding passage opening on the diffusor, is also produced. The connecting pin is then mushroomed, and the diffusor is secured to the heat exchanger block thereabove. In particular the mounting can be simplified, and the diversity of parts can be reduced by means of the integral embodiment of the connecting pin on the heat exchanger block.

In an advantageous further development of the solution according to the invention, the securing is carried out by means of a deformation of the at least one connecting pin by insertion of an expanding mandrel. The free end, which remains free on the diffusor after the insertion of the connecting pin into a passage opening (i.e. the at least one connecting pin has a larger length than the thickness of the through hole), can in particular be deformed by inserting an expanding mandrel. This represents a simple, inseparable mechanical connecting option.

Further important features and advantages of the invention follow from the subclaims, from the drawings, and from the corresponding figure description by means of the drawings.

It goes without saying that the above-mentioned features and the features, which will be described below, cannot only be used in the respective specified combination, but also in other combinations, or alone, without leaving the scope of the present invention.

Preferred exemplary embodiments of the invention are illustrated in the drawings and will be described in more detail in the description below, whereby identical reference numerals refer to identical or similar or functionally identical components.

### BRIEF DESCRIPTION OF THE DRAWINGS

In each case schematically

FIGS. 1a-1c show a top view, a sectional view, and a perspective view of a schematic heat exchanger comprising diffusor in a first state;

FIGS. 2a-2c show a top view, a sectional view and a perspective view of the schematic heat exchanger, to which the diffusor is secured in a second state according to the invention.

### DETAILED DESCRIPTION

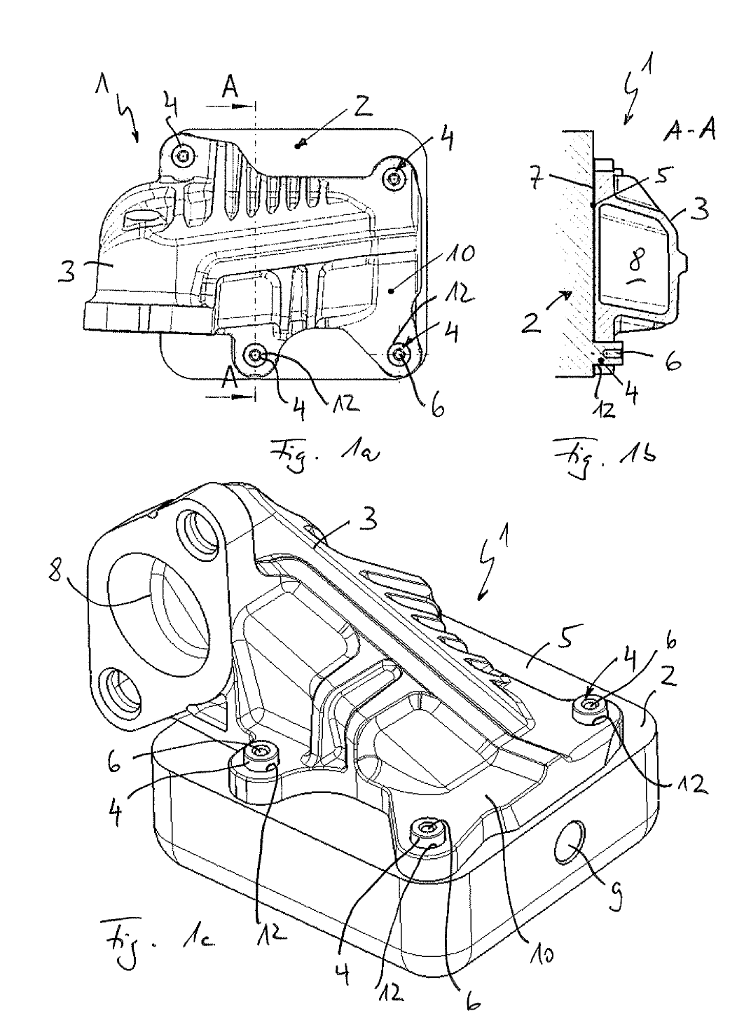

FIG. 1 shows a schematic illustration of a schematic heat exchanger 1. The illustration is schematic in the sense that a heat exchanger block 2 is only illustrated as simple module to emphasize the characteristics, which are significant for the invention, more clearly. FIG. 1a in particular shows a top view onto the schematic heat exchanger 1, which has a schematic module as heat exchanger block 2 and a diffusor 3 thereon. In FIG. 1a, the heat exchanger 1 further has four connecting pins 4, which serve to secure the diffusor 3 to the heat exchanger block 2. Prior to the final securing of the diffusor 3, the connecting pins 4 further already serve for a positioning of the diffusor 3, in that they project through passage openings 12 of the diffusor 3. This can be seen in more detail in the sectional view of FIG. 1b, which illustrates a sectional view of the heat exchanger 1 along the line A-A in FIG. 1a.

FIG. 1b in particular shows the schematic heat exchanger 1 along a section, which goes through one of the connecting pins 4 of the schematic heat exchanger block 2, so that it can be seen on the one hand in FIG. 1b that the connecting pin 4 is embodied in one piece or integrally respectively, with a surface 5 of the heat exchanger block 2 and further has a larger axial length than the thickness of a base plate 10 of the diffusor 3, so that a free end of the connecting pin 4 projects beyond the base plate 10 of the diffusor 3. FIG. 1b further also shows that the connecting pin 4 is hollowed out from the free end and has a type of blind hole 6, which leads to an easier deformability of the free end of the connecting pin 4. A seal 7, for example a metal seal, is further arranged between the surface 5 of the schematic heat exchanger block 2 and the diffusor 3. FIG. 1b further also illustrates a fluid duct 8, which serves the purpose of guiding the fluid through the diffusor 3.

FIG. 1c shows the heat exchanger 1 in the state of FIG. 1a in a perspective view. In particular, FIG. 1c also schematically illustrates a connection 9, which is to represent a connection for a supply or discharge of an operating medium, for example a coolant, in the event that the heat exchanger 1 is used as cooling device (e.g. intercooler or exhaust gas cooler). In the perspective view of FIG. 1c, the free ends of the connecting pins 4, which project beyond the base plate 10 of the diffusor 3, and the blind holes 6 arranged therein, can be seen as well.

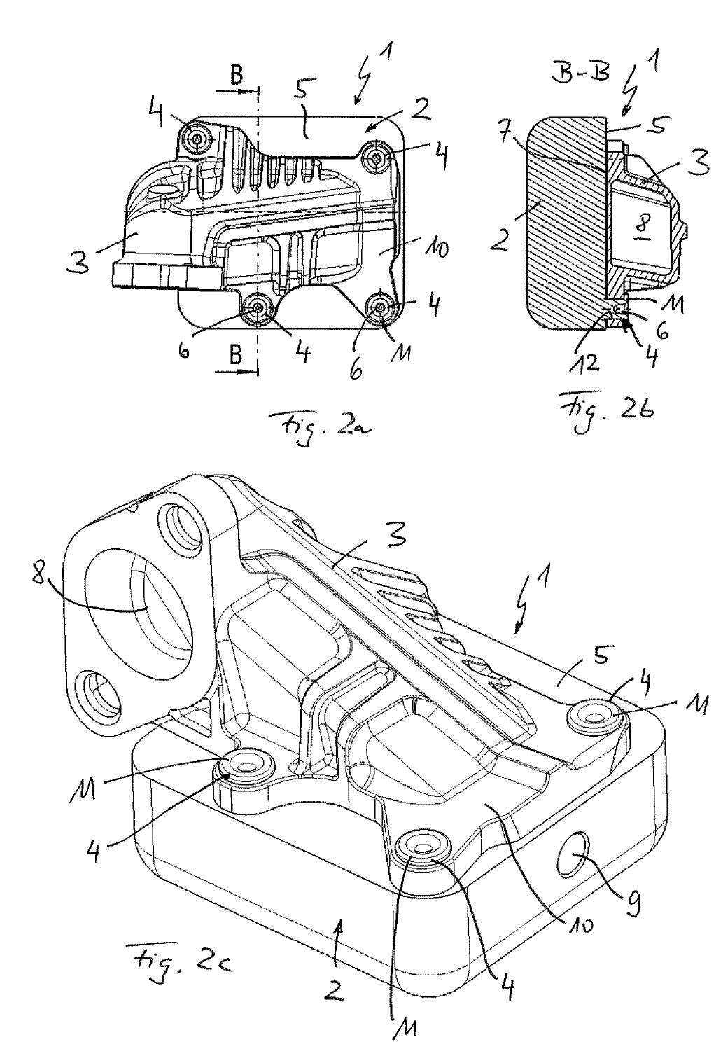

FIG. 2 shows a top view, a sectional view, and a perspective view of the schematic heat exchanger 1 of FIG. 1 in a second state, in which the diffusor 3 is already secured to the heat exchanger block 2. In particular, FIG. 2a shows the heat exchanger (as does FIG. 1a) in a top view, but in the state, in which the connecting pins 4 of the heat exchanger 2 are in each case deformed on their free end and have a mushroomed head 11, so that the diffusor 3 is secured or fastened and can no longer be removed.

This can be seen in FIG. 2b, which, in turn, illustrates a sectional view along line B-B in FIG. 2a and which thus essentially corresponds to FIG. 1b, whereby the deformed or beaded end of the connecting pin 4 of the schematic heat exchanger block 2 now bears on the base plate 10 of the diffusor 3. Such a deformation can occur for example by means of a (wobble)riveting process or an expanding mandrel.

FIG. 2c, in turn, shows the heat exchanger 1 in a perspective view and, except for the deformation of the connecting pin 4, corresponds to FIG. 1c. It is also shown here, in turn, that the free ends of the connecting pins 4 are now beaded, deformed or ground, so that the diffusor 3 is now secured to the heat exchanger block 2.

The heat exchanger 1 according to the invention is produced as follows: First of all, a heat exchanger block 2 comprising at least one connecting pin 4, which sticks out from the surface 5 thereof, is produced, as well as a diffusor 3. The diffusor 3 is then attached to the heat exchanger block 2 in such a way that the at least one connecting pin 4 engages through a corresponding passage opening 12 on the diffusor 3. A positionally accurate positioning of the diffusor 3 on the heat exchanger block 2 occurs through this.

The connecting pin 4 is then mushroomed on its head 11, that is, on its free end and the diffusor 3 is secured to the heat exchanger block 2 thereabove. The mushrooming can take place, for example, by an insertion of an expanding mandrel or of a wobble riveting tool into the bore 6.

The integral molding/embodying of at least one connecting pin 4 (preferably a plurality of connecting pins) to a surface 5 of the heat exchanger block 2 can take place, for example, by means of a casting process.

1. A heat exchanger comprising a heat exchanger block and a diffusor connected thereto, wherein:
at least one connecting pin is integrally molded to a surface of the heat exchanger block;
at least one passage opening, through which the at least one connecting pin engages when the heat exchanger is mounted, is arranged on the diffusor; and
the at least one connecting pin has a widened head via which the diffusor is secured to the heat exchanger block.

2. The heat exchanger according to claim 1, wherein the heat exchanger block is cast together with the at least one connecting pin.

3. The heat exchanger according to claim 1, wherein a material of the at least one connecting pin is the same as a material of the surface of the heat exchanger block.

4. The heat exchanger according to claim 1, wherein the at least one connecting pin includes a total of four connecting pins.

5. The heat exchanger according to claim 1, wherein the at least one connecting pin is hollow at least on a free end thereof.

6. A method for producing a heat exchanger comprising:
producing a heat exchanger block with at least one connecting pin sticking out from a surface thereof;
attaching a diffusor to the heat exchanger block in such a way that the at least one connecting pin engages through a corresponding passage opening on the diffusor;
wherein the at least one connecting pin is mushroomed and the diffusor is secured to the heat exchanger block thereabove.

7. The method according to claim 6, further comprising introducing a bore into a free end of the at least one connecting pin.

8. The method according to claim 6, wherein producing the heat exchanger block includes casting the heat exchanger block together with the at least one connecting pin.

9. The method according to claim 6, wherein a material of the at least one connecting pin is the same as a material of the surface of the heat exchanger block.

10. The method according to claim 8, wherein a material of the at least one connecting pin is the same as a material of the surface of the heat exchanger block.

11. The method according to claim 6, wherein the at least one connecting pin includes a total of four connecting pins.

12. The method according to claim 7, wherein the at least one connecting pin includes a total of four connecting pins.

13. The heat exchanger according to claim 2, wherein a material of the at least one connecting pin is the same as a material of the surface of the heat exchanger block.

14. The heat exchanger according to claim 2, wherein the at least one connecting pin includes a total of four connecting pins.

15. The heat exchanger according to claim 2, wherein the at least one connecting pin is hollow at least on a free end thereof.

16. A heat exchanger comprising:
a heat exchanger block;
a diffusor;
at least one connecting pin integrally molded to a surface of the heat exchanger block, the at least one connecting pin having a widened head securing the diffusor to the heat exchanger block, the at least one connecting pin being hollow at least on a free end thereof; and
at least one passage opening arranged on the diffusor, the at least one connecting pin engaging through the at least one passage opening when the heat exchanger is mounted.

17. The heat exchanger according to claim 16, wherein the heat exchanger block is cast together with the at least one connecting pin.

18. The heat exchanger according to claim 16, wherein a material of the at least one connecting pin is the same as a material of the surface of the heat exchanger block

19. The heat exchanger according to claim 16, wherein the at least one connecting pin includes a total of four connecting pins.

20. The heat exchanger according to claim 17, wherein the at least one connecting pin includes a total of four connecting pins.
